(19) United States
(12) Patent Application Publication
(10) Pub. No.: US 2024/0420496 A1
(43) Pub. Date: Dec. 19, 2024

(54) LAYOUT AWARE MULTI-MODAL NETWORKS FOR DOCUMENT UNDERSTANDING

(71) Applicant: Oracle International Corporation, Redwood Shores, CA (US)

(72) Inventors: Zheng Wang, Sammamish, WA (US); Tao Sheng, Bellevue, WA (US); Yazhe Hu, Bellevue, WA (US); Mengqing Guo, Redmond, WA (US); Liyu Gong, Lexington, KY (US); Jun Qian, Redwood Shores, CA (US); Katharine D'Orazio, Brooklyn, NY (US)

(21) Appl. No.: 18/210,498

(22) Filed: Jun. 15, 2023

(51) Int. Cl. G06V 30/413; G06V 30/19; G06V 30/412; G06V 30/416

(52) U.S. Cl. CPC G06V 30/413; G06V 30/19147; G06V 30/412; G06V 30/416

(57) ABSTRACT

Techniques for layout-aware multi-modal networks for document understanding are provided. In one technique, word data representations that were generated based on words that were extracted from an image of a document are identified. Based on the image, table features of one or more tables in the document are determined. One or more table data representations that were generated based on the table features are identified. The word data representations and the one or more table data representations are input into a machine-learned model to generate a document data representation for the document. A task is performed based on the document data representation. In a related technique, instead of the one or more table data representations, one or more layout data representations that were generated based on a set of layout features, of the document, that was determined based on the image are identified and input into the machine-learned model.

### TECHNICAL FIELD

The present disclosure relates generally to machine learning and, more particularly, to multi-modal networks to better understand documents.

### BACKGROUND

Automated document processing is a common endeavor and presents numerous challenges. Part of the challenges result from the existence of many different types of documents, such as tax forms, job applications, resumes, invoices, passports, drivers' licenses, technical articles, essays, etc. Each type of document has a different structure and layout, which makes it difficult for automated systems to properly extract document content and metadata, identify key-value pairs, and classify extracted content. Additionally, there may be significant variation within a single document type, such as many different ways a resume may be formatted.

Because manual processing, extraction, and classifying is infeasible due to the large volume of documents that a typical enterprise ingests and processes, automated techniques have been developed. One of those techniques involves machine-learned (ML) document understanding models that generate a data representation (or embedding) for a document based on content of the document, such as the words that are detected in the document. However, such document understanding models have relatively poor performance in document classification and other end tasks (e.g., key-value pair extraction). One possible reason for the poor performance is the complicated layouts to which documents typically conform.

Another issue with current automated document processing (e.g., in the area of key-value extraction) is model regression. For example, for current document understanding models, it is difficult to improve a single key without any regression on the other keys.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example model architecture for enhancing document understanding, in an embodiment;

FIG. 2 is a block diagram that depicts a portion of an example document and an example pair of input texts from different blocks or sections of the example document, in an embodiment;

FIG. 3 is a block diagram that depicts an example pre-training pipeline for global layout consistency matching, in an embodiment;

FIG. 4 is a block diagram that depicts an example pre-training pipeline for table content detection, in an embodiment;

FIG. 5 is a block diagram that depicts an example fine-tuning pipeline, in an embodiment;

FIG. 6 is a flow diagram that depicts an example process for leveraging a document understanding model, in an embodiment;

FIG. 7 is a block diagram that illustrates an example computer system upon which an embodiment of the invention may be implemented;

FIG. 8 is a block diagram of a basic software system that may be employed for controlling the operation of the example computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for generating and leveraging a more accurate document understanding model are provided. In one technique, the document understanding model includes new input modalities to enhance the paragraph/block level layout understanding. Specifically, output embeddings from a table detection model and/or a document layout detection model carry rich global level layout information and are input to the document understanding model. In a related technique, a semi-supervised training task for paragraph/block level layout consistency is added to enhance model performance on documents with complicated layouts.

Embodiments improve computer-related technology. Particularly, embodiments enhance the understanding of a document by taking into account table features and/or global layout document features. As a result, machine-learned tasks, such as document classification and key-word extraction, are improved with increased accuracy and less errors, particularly with respect to documents with relatively complicated layouts.

### Model Architecture

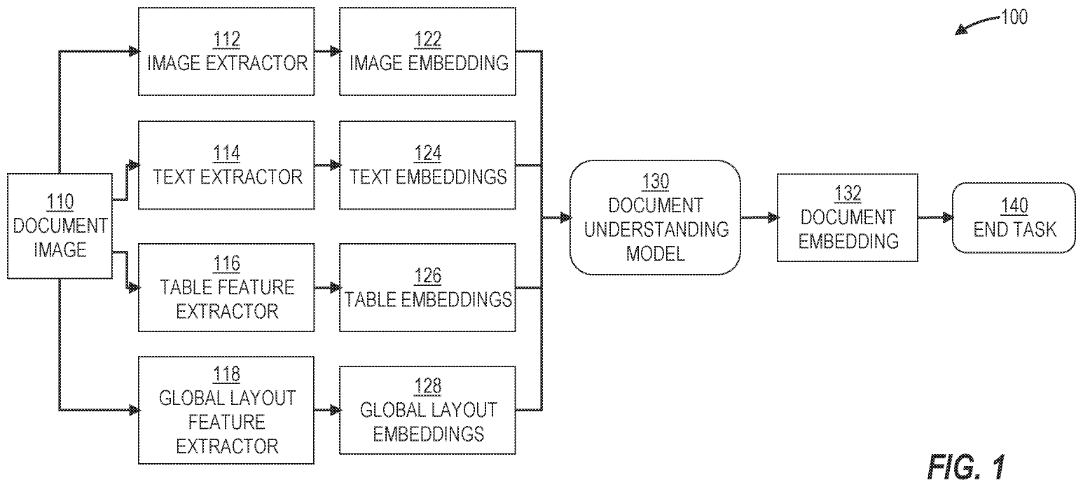

FIG. 1 is a block diagram that depicts an example model architecture 100 for enhancing document understanding, in an embodiment. Model architecture 100 includes four extractors 112, 114, 116, and 118, each producing a respective data representation (122-128) of the data extracted by the corresponding extractor. While four extractors are depicted, model architecture may comprise fewer or more extractors. For example, model architecture 100 may comprise only one of extractors 112 or 114. As another example, model architecture 100 may comprise only one of extracts 116 or 118.

Model architecture 100 also includes a document understanding model 130 that, given the data representations 122-128 as input, produces a document data representation (or embedding) 132. Lastly, model architecture 100 includes an end task 140 that takes document embedding 132 as input and generates an output, which varies depending on end task 140. Examples of end task 140 include a classification of a document that is input to extractors 112-118, recognizing a named entity, key-value pair extraction, and document-based question and answering. The embeddings could also be used in document matching and retrieval.

A digital image 110 of a document is input to extractors 112-118. A document may be a single page or multiple pages. If a document comprises multiple pages, then there may be a different digital image for each page. Digital image 110 may be in one of multiple digital image formats, such as jpeg or png. Each of extractors 112-118 includes an analyzer and a data representation generator. Each analyzer analyzes a different aspect of digital image 110.

### Image Feature Extractor

An analyzer of image feature extractor 112 analyzes pixel-level information of digital image 110. The analyzer detects layout components (e.g., paragraphs, figures) as objects from digital image 110. The analyzer also focuses on other features at different layers, such as edges and lines, and words and paragraphs.

The image features that the analyzer of image feature extractor 112 extracts are input to the data representation generator of image feature extractor 112. Each data representation generator generates a data representation or “embedding.” A data representation (or embedding) may be a single dimension vector of multiple values of size N or a two-dimensional matrix of size N×M. A data representation generator comprises a model, such as a neural network that has been trained using one or more machine-learning techniques.

### Text Extractor

Text extractor 114 comprises an optical character recognition (OCR) component (a type of “analyzer”) that extracts individual text items, such as words or phrases. Each text item is associated with an embedding in a mapping of text items-to-embeddings. The mapping may be limited to certain words or phrases may intentionally exclude common words, such as stop words. The text items may pertain to (or be limited to) a certain subject matter domain, such as tax forms, passports, or invoices. If text extractor 114 has access to multiple mappings, then there may be overlap in text items in the multiple mappings.

The text embeddings in the mapping(s) of text items-to-embeddings may be pre-trained text embeddings, i.e., embeddings that have already been generated based on a certain text corpus. The text embeddings may be updated when training document understanding model 130. In this way, the text embeddings do not start out as randomly generated embeddings and, therefore, are able to converge faster.

### Table Feature Extractor

Table feature extractor 116 includes an analyzer that detects any tables in digital image 110 and, for each detected table, determines one or more features of the table. Example features of a table include coordinates of the table, a width of the table, a height of the table, a number of columns of the table, and a number of rows of the table.

Coordinates of a table may include a vertical and horizontal offset into digital image 110 where the table is located. An offset may be a number of pixels from an origin (e.g., the top left corner of digital image 110) or may be a percentage of the A set of table features of a table may include four sets of coordinates, one for each corner of the table. Alternatively, a set of table features of a table may include only two sets of coordinates, one for one corner of the table and the other for the opposite corner of the table. The other corners may be derived based on these two sets of coordinates.

A width and height of a table may be measured in one or more units, such as number of pixels or percentage of the entire width or height of digital image 110. For example, a width of a table may be 5% of the width of digital image 110, indicating that the table is relatively narrow. As another example, a height of a table may be 50% of the height of digital image 110, indicating that the table is relatively tall or prominent.

Table feature extractor 116 includes a data representation generator that generates a table data representation (or embedding) 126 based on the table features that were identified. For example, the data representation generator comprises a neural network that takes the identified table features as input and generates an embedding. The neural network may have been trained on multiple training instances in conjunction with the training of the other neural networks of the other data representation generators, including document understanding model 130.

### Global Layout Feature Extractor

Global layout feature extractor 118 includes an analyzer that analyzes digital image 110 at a global perspective to identify layout features of one or more components of digital image 110. Examples of layout components include figures, paragraphs, and tables. Examples of features of a layout component includes coordinates of the layout component, size of the layout component, and a trained embedding of the layout component. Layout features and table features are focusing on different detail levels. For example, a layout feature focuses on an entire table while a related table feature focuses on the rows/cells within the table.

Global layout feature extractor 118 also includes a data representation generator that generates a data representation for digital image 118 based on layout features that were detected. The data representation generator takes the layout features as input and outputs a data representation.

### Document Understanding Model

In an embodiment, document understanding model 130 is limited to receiving a certain number of data representations/embeddings from each extractor. For example, document understanding model 130 receives a single embedding from image feature extractor 112, a maximum of five hundred embeddings from text extractor 114, a maximum of five embeddings from table feature extractor 116, and a single embedding from global layout feature extractor 118. If more words than the maximum number of words are detected in digital image 110, then one or more word embeddings (above the maximum number) are not generated or are not transmitted to document understanding model 130. For example, if six hundred words are detected, then one hundred of the most common words (e.g., as determined in a certain corpus of text) are disregarded and word embeddings for those words are not sent to document understanding model 130.

In some cases, there may be fewer data representations from an extractor (for a digital image) than a maximum number of embeddings from that extractor (for the digital image). For example, there may be two tables detected in digital image 110 but document understanding model 130 may be configured to take a maximum of five embeddings from table feature extractor 116. The three possible embeddings that correspond to three tables that are not detected in digital image 110 (because they do not exist) may be empty or “padded” with zeros.

Document understanding model 130 comprises a neural network that takes data representations (from extractors 112-118) as input and outputs a document data representation or embedding 132, which represents digital image 110. Document embedding 132 is input to end task 140, which outputs a value that corresponds to the type of task, such as binary classifier (e.g., whether digital image 110 contains a certain attribute or characteristic) or a document classifier, where the document (depicted in digital image 110) may belong to one of multiple classes. End task 140 is not limited to any particular configuration and may comprise multiple inputs, not just document embedding 132. For example, end task 140 may comprise another neural network and/or a logistic regression model that takes other input.

### Pre-Training

“Pre-training” in the context of document understanding refers to training a model to learn a general semantical understanding of content from a document. In this phase, data (e.g., tens of millions of documents) are fed to document understanding model 130 the weights thereof are automatically tuned to correctly predict the contents from the documents. However, pre-training is performed before the main training phase where output of document understanding model 130 is input to end task 140.

In the pre-training phase, one or more self-supervised tasks are performed with respect to input documents. A self-supervised task comprises two parts: the data input and a label. In a self-supervised task, the label is automatically generated without human intervention. An example of a self-supervised tasks is Masked Language Modeling (MLM), in which words are randomly masked from a sentence. The masked words become the labels for this task and a model is tuned to predict the masked words.

### Global Layout Consistency Matching

In an embodiment, a self-supervised task is executed to allow document understanding model 130 to learn global layout consistency. This self-supervised task is referred to as “global layout consistency matching.” In this task, the overall model is asked to predict, for each pair of input text (e.g., two different words), whether the pair of input text are coming from the same layout block. Each input text in the pair may be delimited from other possible input text by whitespace or punctuation, such as a period, comma, colon, semicolon, etc. This task helps the overall model capture the layout information embedded in the document.

In an embodiment, in order to execute the global layout consistency matching task, a training data generator automatically generates training instances based on analyzing sectioned documents. A training data generator may be implemented in software, hardware, or any combination of software and hardware. A sectioned document is one that has already been sectioned or divided into distinct sections or blocks. An example of a sectioned document is an HTML document that has HTML tags that define different sections, such as paragraph tags, table tags, and section tags. Another example of a sectioned document is a PDF document (except image-only PDFs) that has defined sections. Other examples include Word documents and any markup language documents, such as XML, Tex, and LaTex.

The training data generator selects two pairs of input text (such as a word or phrase) and generates a label indicating whether the two input texts come from different sections. If the two input texts come from the same section of a sectioned document (e.g., determined based on same set of tags or pathnames), then the training data generator generates a label that indicates that the two input texts come from the same section. An example of such a label is ‘1.’ Alternatively, if the two input texts do not come from the same section of a sectioned document, then the training data generator generates a label that indicates that the two input texts do not come from the same section. An example of such a label is ‘0.’ For each pair of input texts and a corresponding label, the training data generator generates a single training instance that is added to a set of training data for the model.

The training data generator may generate many training instances. For example, after selecting a single word in a section of a sectioned document, the training data generator generates a training instance for each other word in the section, which could be over a hundred training instances (all having the same positive label). Also, the training data generator may generate (for the selected word) another training instance for each word that is found outside the section, which could be many more training instances, each having a negative label.

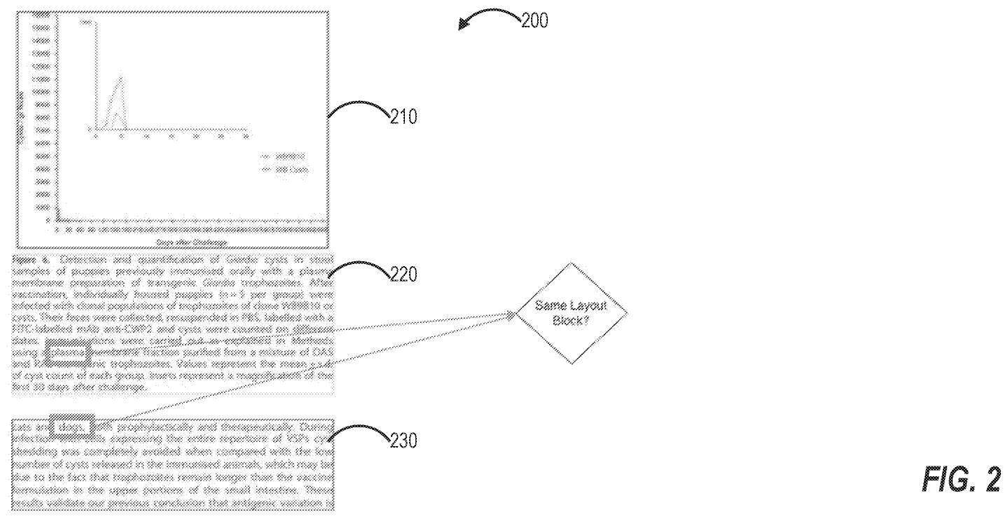

FIG. 2 is a block diagram that depicts a portion 200 of an example document and an example pair of input texts from different blocks or sections of the example document, in an embodiment. Portion 200 comprises a FIG. 210, a figure section 220, and a non-figure section 230. Figure section 220 and non-figure section 230 are different sections of the same document. In this example, a training data generator selects two words: “plasma” from figure section 220 and “dogs” from non-figure section 230. The training data generator determines that “plasma” and “dogs” are from different sections. This determination may be based on section tags (or pathnames) that are associated with the two sections from which the selected words originate.

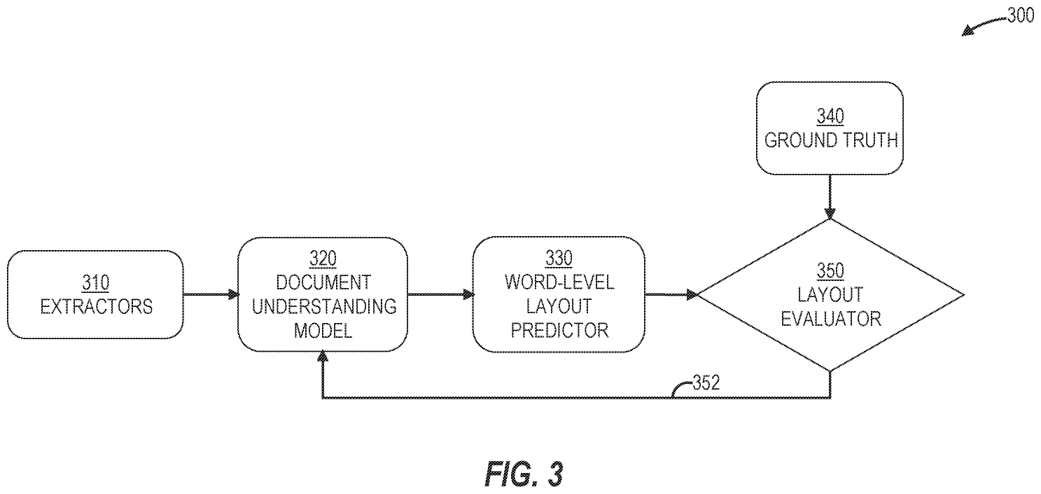

FIG. 3 is a block diagram that depicts an example pre-training pipeline 300 for global layout consistency matching, in an embodiment. Pre-training pipeline 300 includes similar elements as model architecture 100. Pre-training pipeline 300 includes a set of extractors 310, such as a visual extractor, an OCR extractor, a layout extractor, and/or a table extractor. Thus, set of extractors 310 may include any one of these extractors or any combination thereof. Pre-training pipeline 300 also includes a document understanding model 320, a word-level layout predictor 330, a ground truth 340, and a layout evaluator 350. Thus, while an eventual use case involving document understanding model 320 might be document classification or named entity recognition, this pre-training phase involves predicting whether two words come from the same section or block.

All tokens/words extracted from a document are input to the model simultaneously and document understanding model 320 outputs an embedding per token (and other additional embeddings for an entire document as a global representation). For pre-training, a trainer samples pairs of embeddings (representing tokens) according to the layout label and sends the concatenated embeddings to a classifier (word-level layout predictor 330 in this example). The prediction (output) of the classifier may be in a range of 0 to 1 to indicate whether the pair of tokens is from the same block/section.

Layout evaluator 350 compares the prediction with the label of the corresponding training instance, which comes from ground truth 340. Based on the output 352 of the comparison, weights in document understanding model 320 (and, optionally, in one or more models of the set of extractors 310) are updated, for example, using back propagation.

### Table Content Detection

In an embodiment, a self-supervised task is executed to assist document understanding model 130 in capturing table contents from a document. This self-supervised task is referred to as “table content detection.” Table content detection leverages the overall model to predict, at a word level, whether a given word is from a table or not. Additionally, the overall model may be used to predict whether the given word is from a header of the table or from content of the table. A table header may include columns names and a table name, while table content includes any content that is within a row or column of the table, but nothing outside a row or column.

A training data generator may use documents within well-defined tables to generate training instances to train document understanding model 130. Again, examples of such documents include HTML documents and PDF documents with tags or table information that allows the training data generator to determine whether a text item in a document is part of a table or not part of a table, or, in a related embodiment, whether a text item in a document is part of a header of a table, part of the content of the table, or not part of the table.

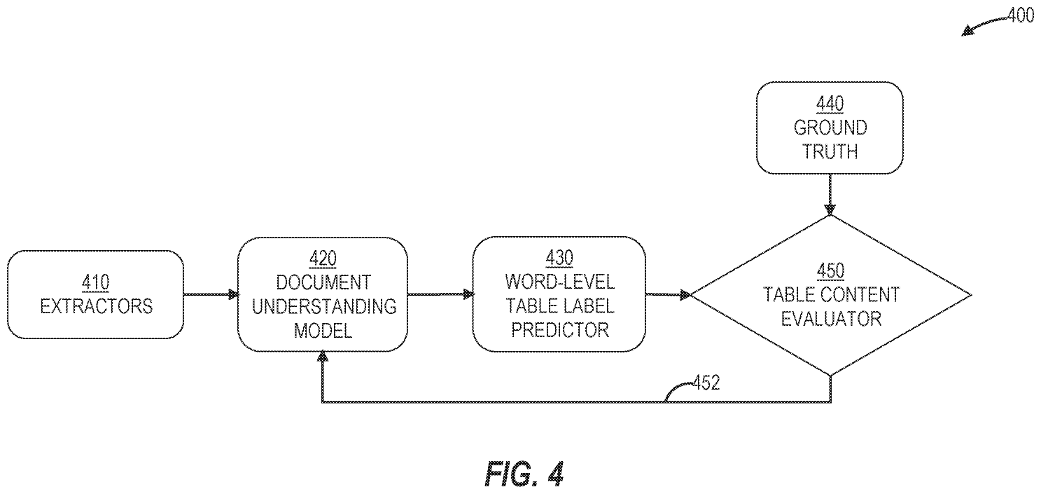

FIG. 4 is a block diagram that depicts an example pre-training pipeline 400 for table content detection, in an embodiment. Pre-training pipeline 400 includes similar elements as pre-training pipeline 300. Pre-training pipeline 400 includes a set of extractors 410, such as a visual extractor, an OCR extractor, a layout extractor, and a table extractor. Pre-training pipeline 400 also includes a document understanding model 420, a word-level table label predictor 430, a ground truth 440, and a table content evaluator 450. Thus, while an eventual use case involving document understanding model 420 might be document classification or named entity recognition, this pre-training phase involves predicting whether a text item comes from a table or not, or from a table header, table content, or not from any portion of table.

Given a training instance that comprises a token embedding and a label, the output of document understanding model 420 is input to word-level table level predictor 430, the output of which is a prediction of whether the token (that corresponds to the token embedding) came from a table or not (or whether the token comes from a table header, table content, or not from any table). Table content evaluator 450 compares the prediction with the label of the training instance, which comes from ground truth 440. Based on the output 452 of the comparison, weights in document understanding model 420 (and, optionally) in one or more models of the set of extractors 410 are updated, for example, using back propagation.

In a related example, a training instance comprises two token embeddings and multiple labels, each label corresponding to a different task, such as whether the corresponding tokens belong to the same table row, the same table column, and the same table cell. Each row, column, and cell evaluation is a separate task (head). Therefore, the output of document understanding model 420 may comprise multiple predictions, such as multiple values between 0 and 1, each value corresponding to a different task.

### Fine-Tuning

The pre-trained document understanding model serves as an engine to provide the ability to understand document content. A task-specific head is designed and attached “on top of” (or immediately after) the document understanding model in order to make a prediction according to the task. Examples of such a task include document classification, named entity recognition, and key-value extraction.

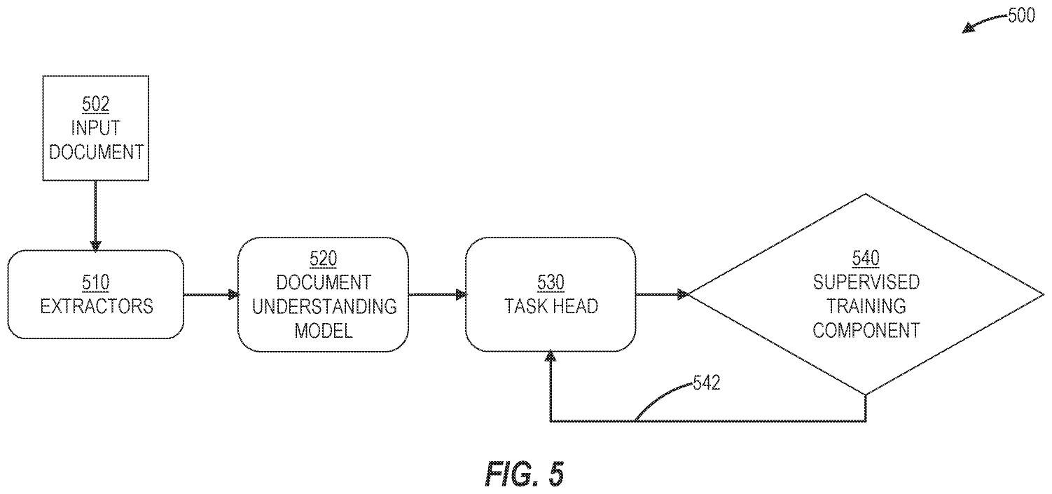

FIG. 5 is a block diagram that depicts an example fine-tuning pipeline 500, in an embodiment. Fine-training pipeline 500 includes similar elements as pre-training pipeline 400. Fine-tuning pipeline 500 includes an input document 502 (e.g., an image), a set of extractors 510, such as a visual extractor, an OCR extractor, a layout extractor, and/or a table extractor. Fine-tuning pipeline 500 also includes a document understanding model 520, a task head 530, a supervised training component 540. The supervised training component 540 has access to training data, which includes label data or ground truth. As FIG. 5 depicts, the weights of task head 530 are updated 542 based on the evaluation of each training instance in order to fit the supervised training objective. Also, the weights of the (pre-trained) document understanding model 520 are loaded before the fine-tuning process. In a related embodiment, the weights of document understanding model 520 are also adjusted to fit the task objective.

Thus, document understanding model 520 (which includes the weights that were generated for document understanding model 520 during a pre-training process) may be used when training different task heads. The weights of document understanding model 520 may be further modified during a fine-tuning process of each one of the different task heads. Therefore, if weights of document understanding model 520 are not modified during the fine-tuning corresponding to different tasks, then the same document understanding model 520 is used for those different tasks. Alternatively, if weights of document understanding model 520 are modified during the fine-tuning corresponding to different tasks, then different versions of the document understanding model 520 (where a “different version” means different weights thereof) are used with the different tasks.

### Example Process

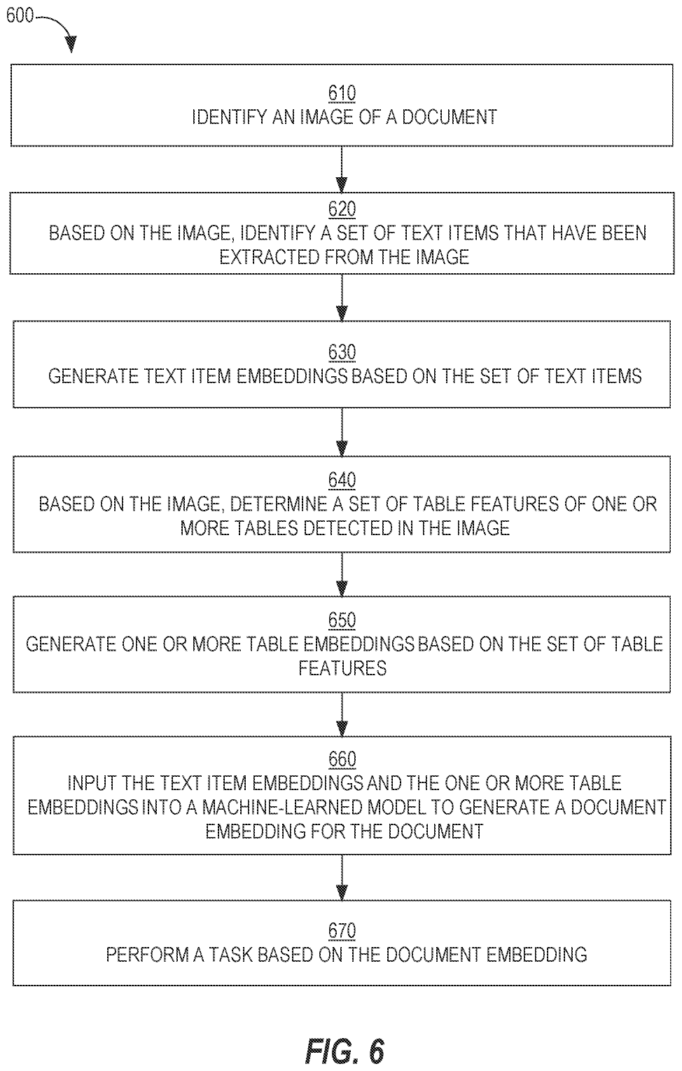

FIG. 6 is a flow diagram that depicts an example process 600 for leveraging a document understanding model, in an embodiment. Process 600 may be implemented in software, hardware, or any combination of software and hardware. For example, process 600 may be implemented by one or more computer processes executing software code written in a high level programming language, such as Java or C++. Embodiments are not limited to any programming language or whether specialized hardware is utilized.

At block 610, an image of a document is identified. The image may originate from one of numerous data sources, such as a database of images or a remote computing device, such as a scanning device, a digital camera, or laptop computer.

At block 620, based on the image, a set of text items that is extracted from the image is identified. Thus, block 620 may be preceded by an OCR step that automatically recognizes text items in the image. A text item may be a word or a phrase comprising multiple words.

At block 630, text item embeddings are generated based on the set of text items. Block 630 may be performed by an OCR extractor.

Although not described in reference to FIG. 6, process 600 may also involve identifying a set of image features based on the image, which features may be generated by an image feature extractor. Thereafter, process 600 may also involve generating image embeddings based on the set of image features.

At block 640, based on the image, a set of table features of one or more tables in the document is determined. The one or more tables may have been recognized using an OCR process or another process for automatically recognizing tables in documents. Such recognition may involve identifying parallel horizontal lines and parallel vertical lines that cross each other and determining that characters are detected among those lines.

At block 650, one or more table embeddings are generated based on the set of table features. Block 650 may be performed by a table feature extractor and may involve one or more neural networks.

At block 660, the text item embeddings and the one or more table embeddings are input into a machine-learned model to generate a document embedding for the document. (If there are other embeddings, such as image embeddings, then those embeddings are also input to the machine-learned model in order to generate the document embedding.) Thus, the machine-learned model may have already been trained previous to block 610. Such training may have involved one or more self-supervised tasks and training based on a different specific end-task.

At block 670, a task is performed based on the document embedding. The task may be a classification task, a key-value extraction task, or a named entity recognition task.

While process 600 involves generating and leveraging one or more table embeddings, embodiments may additionally or alternatively involve generating and leveraging global layout embeddings based on features of components detected in the image, such as paragraphs and figures.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

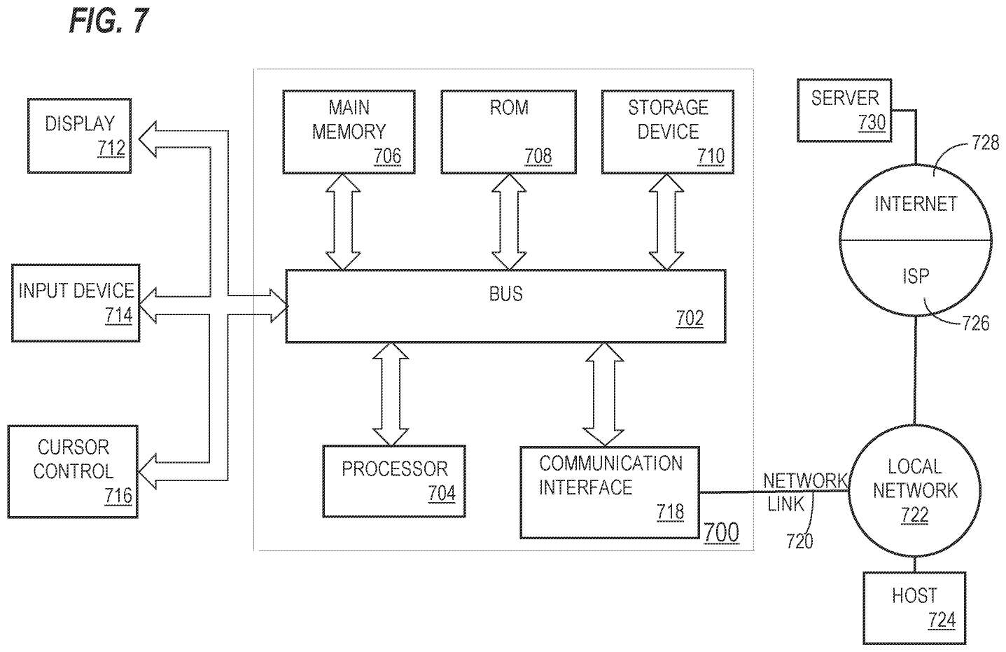

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

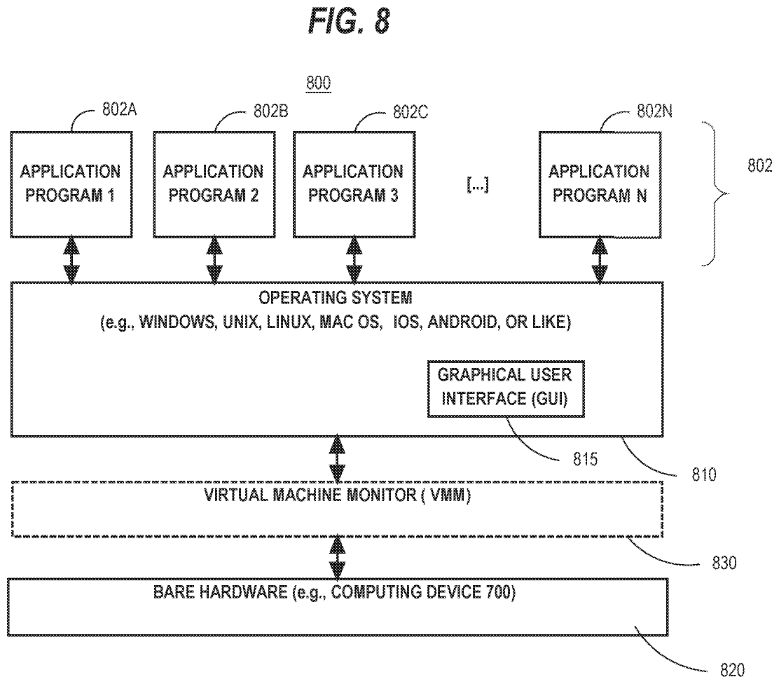

FIG. 8 is a block diagram of a basic software system 800 that may be employed for controlling the operation of computer system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of word data representations that was generated based on a set of words that was extracted from an image of a document;
based on the image, determining a set of table features of one or more tables in the document;
identifying one or more table data representations that were generated based on a set of table features of one or more tables that were detected in the image of the document;
inputting, into a machine-learned model, the plurality of word data representations and the one or more table data representations to generate a document data representation for the document;
performing a task based on the document data representation;
wherein the method is performed by one or more computing devices.

2. The method of claim 1, wherein the set of table features for a table detected in the image of the document includes two or more of:
coordinates of the table,
a width of the table,
a height of the table,
a number of columns in the table, or
a number of rows in the table.

3. The method of claim 1, further comprising:
based on the image, determining a set of layout features of the document;
generating one or more layout data representations based on the set of layout features of the document;
wherein inputting comprises inputting the one or more layout data representations into the machine-learned model;
wherein the document data representation is generated also based on the one or more layout data representations.

4. The method of claim 1, wherein the machine-learned model is a first model, the method further comprising:
automatically generating a plurality of labels, each label for a training instance of a plurality of training instances;
wherein each label of the plurality of labels indicates whether a text item in a corresponding training instance is from a table in a document;
wherein an output of the first model is input to a second model that is different than the first model;
wherein the second model predicts whether an input text item is from a table in a document;
training the first model based on the plurality of training instances.

5. The method of claim 4, wherein each label of the plurality of labels indicates whether the text item is from a header in a table in the document, from content of a table in the document, or not from any table in the document.

6. The method of claim 4, further comprising, prior to training the second model:
for each sectioned document of a plurality of sectioned documents:
selecting a text item from said each sectioned document;
automatically making a determination of whether the text item is part of a table in said each section document;
generating a training instance based on the determination.

7. The method of claim 4, wherein the plurality of training instances is a first plurality of training instance, further comprising:
after training the first model based on the first plurality of training instances, training, based on a second plurality of training instances that is different than the first plurality of training instances, a third model that takes output of the first model as input;
wherein the third model has a first task objective that is different than a second task objective of the second model.

8. The method of claim 7, further comprising updating weights of the first model based on the training of the third model based on the second plurality of training instances.

9. The method of claim 1, further comprising:
identifying one or more image data representations that were generated based on a set of image features of the image of the document;
wherein inputting comprises inputting the one or more image data representations into the machine-learned model;
wherein the document data representation is generated also based on the one or more image data representations.

10. The method of claim 1, further comprising:
based on the image, identifying a set of words extracted from the image;
generating the plurality of word data representations based on the set of words;
based on the image, determining the set of table features of one or more tables in the document;
generating the one or more table data representations based on the set of table features of one or more tables that were detected in the image of the document.

11. The method of claim 1, wherein:
the plurality of word data representations is a plurality of word embeddings;
the one or more table data representations are one or more table embeddings;
the document data representation is a document embedding.

12. A method comprising:
identifying a plurality of word data representations that was generated based on a set of words that was extracted from an image of a document;
identifying one or more layout data representations that were generated based on a set of layout features, of the document, that was determined based on the image;
inputting, into a machine-learned model, the plurality of word data representations and the one or more layout data representations to generate a document data representation for the document;
performing a task based on the document data representation;
wherein the method is performed by one or more computing devices.

13. The method of claim 12, wherein the machine-learned model is a first model, the method further comprising:
automatically generating a plurality of labels, each label for a training instance of a plurality of training instances;
wherein each label of the plurality of labels indicates whether a pair of text items are from a same section in a document;
wherein an output of the first model is input to a second model that is different than the machine-learned model;
wherein the second model predicts whether an input pair of text items are from a same section in a document;
training the second model based on the plurality of training instances.

14. The method of claim 12, further comprising:
based on the image, identifying a set of words extracted from the image;
generating the plurality of word data representations based on the set of words;
based on the image, identifying the set of layout features of the document;
generating the one or more layout data representations based on the set of layout features.

15. One or more non-transitory storage media storing instructions which, when executed by one or more computing devices, cause:
identifying a plurality of word data representations that was generated based on a set of words that was extracted from an image of a document;
based on the image, determining a set of table features of one or more tables in the document;
identifying one or more table data representations that were generated based on a set of table features of one or more tables that were detected in the image of the document;
inputting, into a machine-learned model, the plurality of word data representations and the one or more table data representations to generate a document data representation for the document;
performing a task based on the document data representation.

16. The one or more storage media of claim 15, wherein the set of table features for a table detected in the image of the document includes two or more of:
coordinates of the table,
a width of the table,
a height of the table,
a number of columns in the table, or
a number of rows in the table.

17. The one or more storage media of claim 15, wherein the instructions, when executed by the one or more processors, further comprising:
based on the image, determining a set of layout features of the document;
generating one or more layout data representations based on the set of layout features of the document;
wherein inputting comprises inputting the one or more layout data representations into the machine-learned model;
wherein the document data representation is generated also based on the one or more layout data representations.

18. The one or more storage media of claim 15, wherein the machine-learned model is a first model, wherein the instructions, when executed by the one or more processors, further cause:
automatically generating a plurality of labels, each label for a training instance of a plurality of training instances;
wherein each label of the plurality of labels indicates whether a text item in a corresponding training instance is from a table in a document;
wherein an output of the first model is input to a second model that is different than the first model;
wherein the second model predicts whether an input text item is from a table in a document;
training the first model based on the plurality of training instances.

19. The one or more storage media of claim 18, wherein the instructions, when executed by the one or more processors, further cause, prior to training the second model:
for each sectioned document of a plurality of sectioned documents:
selecting a text item from said each sectioned document;
automatically making a determination of whether the text item is part of a table in said each section document;
generating a training instance based on the determination.

20. The one or more storage media of claim 18, wherein the plurality of training instances is a first plurality of training instance, wherein the instructions, when executed by the one or more processors, further cause:
after training the first model based on the first plurality of training instances, training, based on a second plurality of training instances that is different than the first plurality of training instances, a third model that takes output of the first model as input;
wherein the third model has a first task objective that is different than a second task objective of the second model.
